(19) United States
(12) Patent Application Publication
(10) Pub. No.: US 2002/0138337 A1
(43) Pub. Date: Sep. 26, 2002

(54) Question and answering apparatus, question and answering method, and question and answering program

(75) Inventors: Takashi Yanase, Kawasaki (JP); Isao Namba, Kawasaki (JP); Ryo Ochitani, Kawasaki (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 09/962,219

(22) Filed: Sep. 26, 2001

(30) Foreign Application Priority Data
Mar. 22, 2001 (JP) 2001-083518

(51) Int. Cl. G06F 17/60

(52) U.S. Cl. 705/10

(57) ABSTRACT

A question extraction unit extracts predetermined question elements such as ‘operation’, ‘state’, ‘question’, etc. from question text transmitted from a questioner by electronic mail, etc. A case retrieval unit searches a question and answering case accumulation unit using a question element extracted by the question extraction unit as a retrieval key, and outputs a question case containing a matching question element to a answer presentation unit. The answer presentation unit reads an answer case corresponding to the retrieved question case from a question and answering case accumulation unit, and presents it to the questioner. Thus, the questioner can be provided with a desired answer.

### BACKGROUND OF THE INVENTION

1. Field of the Invention

The present invention relates to a question and answering apparatus, a question and answering method, a question and answering program, and a storage medium storing the program for use in selecting an appropriate case from among stored question and answering cases in response to a question from a questioner.

2. Description of the Related Art

When a user who has purchased a product such as a personal computer, an application program, etc. uses the product, he or she often gets in error and trouble while using it, and has no means to solve the problem. In this case, in the conventional technology, the user has to call up a service staff of the computer manufacturer or the software manufacturer to ask the optimum countermeasure.

Recently, with the remarkable progress of Internet, there has been a system developed to automatically interpret a question from a user received by electronic mail, retrieve an answer to the question from among a number of answers stored in advance, and return the answer to the user by electronic mail.

### SUMMARY OF THE INVENTION

The conventional system has adopted the method of, for example, extracting a keyword from question text, and retrieving question and answering text including the keyword. In this case, the system can fail in retrieving an appropriate answer because question text and answer text do not always contain the same keywords.

In addition, since question text transmitted by electronic mail can contain a salutation and a signature, there has been the problem that appropriate answer text cannot be retrieved.

There has been a further problem that no appropriate answer text can be retrieved because there is no information enough to correctly answer a question only using the information contained in the question text.

The present invention aims at providing a questioner with an appropriate answer to a question. Another object of the present invention is to present an appropriate answer to a questioner although there is no information enough to answer the question.

The question and answering apparatus according to the present invention includes: a question and answering case storage unit for storing the question element of a question case and an answer case; a question extraction unit for extracting the question element from the question received from a questioner; a case retrieval unit for retrieving the question element extracted by the question extraction unit from the question and answering case storage unit; and an answer presentation unit for presenting an answer case corresponding to the question case containing the question element retrieved by the case retrieval unit.

Since the present invention can retrieve the answer text corresponding the question element contained in a question, an appropriate answer corresponding to the contents of the question can be presented to the questioner.

The above mentioned invention can also include a complementary information presentation/selection unit for presenting a question element not contained in the question text of the retrieved question case as complementary information when there are a plurality of question cases retrieved by the case retrieval unit, and receiving the complementary information selected by the questioner.

With the above mentioned configuration, an appropriate answer can be retrieved and satisfy the questioner by presenting complementary information for supplementing the contents of the question to the questioner, and by the questioner selecting one piece or plural pieces of complementary information from the presented complementary information, thereby limiting the retrieval range according to the complementary information although the information contained in the question is not enough to present an appropriate answer to the questioner.

According to the present invention, when the questioner selects complementary information, the case retrieval unit adds the selected question element to a retrieval key to perform the retrieving process again and limit the question case.

With the configuration, although the information about a given question is not enough, the selection items of insufficient question elements are presented to the questioner based on the retrieval result from the case retrieval unit, the questioner selects a question element, the selected question elements are added to the retrieval key, and the retrieving process is performed again. By repeating these interactive processes, an appropriate answer corresponding to the request of the questioner can be retrieved and presented to the questioner.

The above mentioned invention can also include a question and answering case storage control unit for extracting each question element from a plurality of question cases, associating the question element of each question case with an answer case, and storing the cases in the question and answering case storage unit.

With the configuration, when information containing a question case and an answer case is provided, a question element can be extracted from the question case, and the extracted question case and answer case can be associated with each other and stored in the question and answering case storage unit, thereby efficiently retrieving the answer case corresponding to the contents of the question.

According to the above mentioned invention, the question element can be converted into a standard expression according to a predetermined conversion rule, and can be stored in the question and answering case storage unit, or the question extraction unit can convert the extracted question element into a standard expression according to a predetermined conversion rule.

Furthermore, the question and answering case storage control unit can convert the question element of the extracted question case into a standard expression according to a predetermined rule, and store it in the question and answering case storage unit.

With the configuration, high retrieval precision can be obtained when the question element of the question case stored in the question and answering case storage unit is retrieved using the question element extracted from question text as a retrieval key, thereby efficiently retrieving an appropriate answer case in response to a question.

### BRIEF DESCRIPTION OF THE DRAWINGS

FIG. 1 is a block diagram of the question and answering apparatus according to an embodiment of the present invention;

FIG. 2 is a block diagram of the question and answering apparatus according to an embodiment of the present invention;

FIG. 3 is a flowchart of the process performed by the question and answering case storage control unit;

FIG. 4 shows the data structure of question and answering cases accumulated by the question and answering case accumulation unit;

FIG. 5 is a flowchart of the process of extracting a query expressing sentence;

FIG. 6 shows the extraction rule of a query expressing sentence;

FIG. 7 is a flowchart of a converting process into a standard expression;

FIG. 8 shows a conversion rule into a standard expression;

FIG. 9 shows an example of a question case and an answer case;

FIG. 10 shows an example of the data stored by the question and answering case accumulation unit;

FIG. 11 shows an example of a question case and an answer case;

FIG. 12 shows an example of the data stored by the question and answering case accumulation unit;

FIG. 13 is a flowchart of the process performed by the question extraction unit;

FIG. 14 shows an example of a question sent by electronic mail and extracting a query expressing sentence;

FIG. 15 is a flowchart of the process performed by the case retrieval unit;

FIG. 16 shows question cases stored by the question and answering case accumulation unit;

FIG. 17 shows a case retrieved in response to the question case shown in FIG. 16;

FIG. 18 is a flowchart of the process performed by the complementary information input unit;

FIG. 19 shows an example of presenting and selecting probable complementary information;

FIG. 20 is a flowchart of the process performed by the answer presentation unit; and

FIG. 21 shows a storage medium.

### DESCRIPTION OF THE PREFERRED EMBODIMENTS

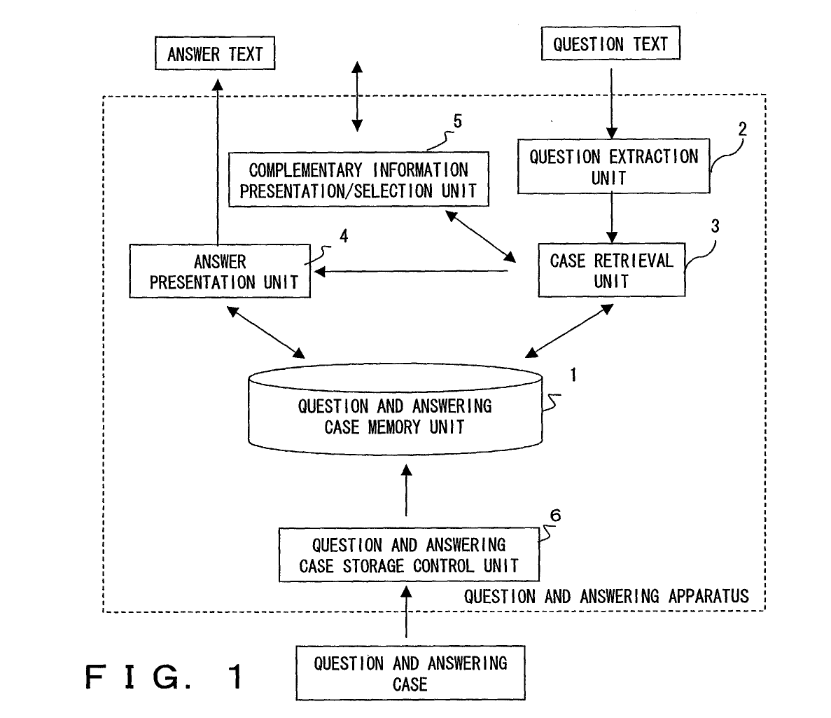

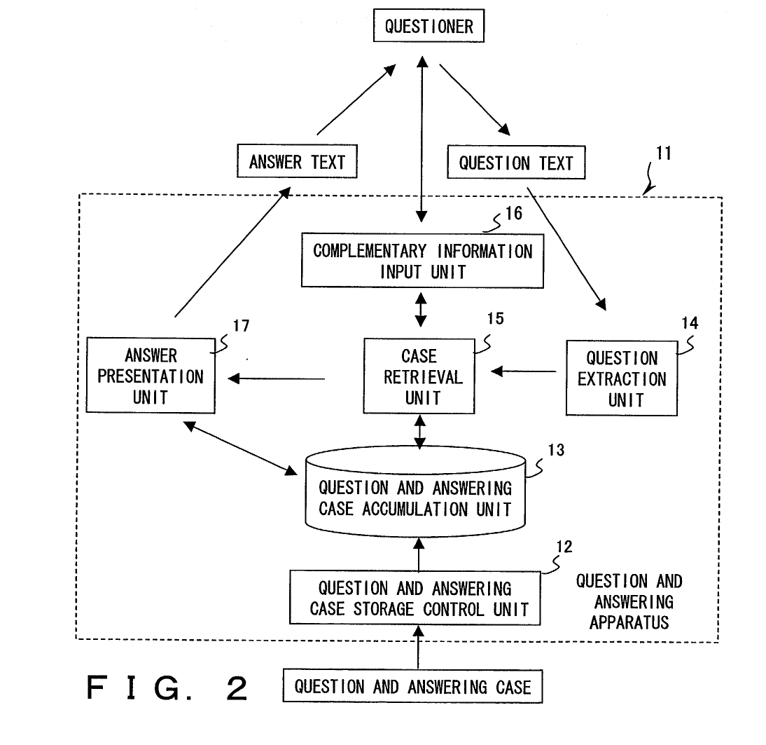

Described below are the preferred embodiments of the present invention. FIGS. 1 and 2 are block diagrams of a question and answering apparatus 11 of the embodiment of the present invention.

The question and answering apparatus 11 is realized by, for example, a computer, a server device, etc. connected to a network. The question and answering apparatus 11 comprises a question and answering case storage control unit 6 or 12, a question and answering case memory unit(storage unit) 1 or a question and answering case accumulation unit 13, a question extraction unit 2 or 14, a case retrieval unit 3 or 15, a complementary information presentation/selection unit 5 or a complementary information input unit 16, and an answer presentation unit 4 or 17.

The question and answering case storage control units 6 and 12 analyze the format of a prepared question and answering case, divide it into a question case and an answer case, extract predetermined query expressing sentences (question elements) such as ‘OPERATION’, ‘STATE’, ‘QUESTION’, etc. from the question case, and store them in the question and answering case memory unit (storage unit)1 and the question and answering case accumulation unit 13 together with the answer case. The question and answering case accumulation unit 13 comprises a storage device, for example, a hardware disk device and an optical storage medium, etc.

The question extraction units 2 and 14 read a question text received from a questioner by electronic mail, etc., extract predetermined query expressing sentences such as ‘OPERATION’, ‘STATE’, ‘QUESTION’, etc., and output them to the case retrieval units 3 and 15.

The question and answering case accumulation unit 13 can be designed not to store the question case itself, but to store the query expressing sentences extracted from the question case and associated with an answer case. Also in this case, the data including the extracted query expressing sentences is referred to as a question case as described below.

The case retrieval units 3 and 15 retrieve the query expressing sentences matching the retrieval key from the question and answering case memory unit 1 and the question and answering case accumulation unit 13.

When there are a plurality of question cases (cases including query expressing sentences matching the retrieval key) retrieved by the case retrieval units 3 and 15, the complementary information presentation/selection unit 5 and the complementary information input unit 16 read the query expressing sentences other than those used as the retrieval key from the question and answering case memory unit 1 and the question and answering case accumulation unit 13, present them as probable complementary information to the questioner, and outputs the query expressing sentences selected by the questioner as an additional retrieval key to the case retrieval units 3 and 15.

The case retrieval units 3 and 15 perform a retrieving process again after adding additional query expressing sentences output from the complementary information presentation/selection unit 5 and the complementary information input unit 16 to the retrieval key to limit the question case.

The answer presentation units 4 and 17 read the question and answering case corresponding to the question case retrieved by the case retrieval units 3 and 15 from the question and answering case accumulation unit 13, and generate answer text to be presented to the questioner.

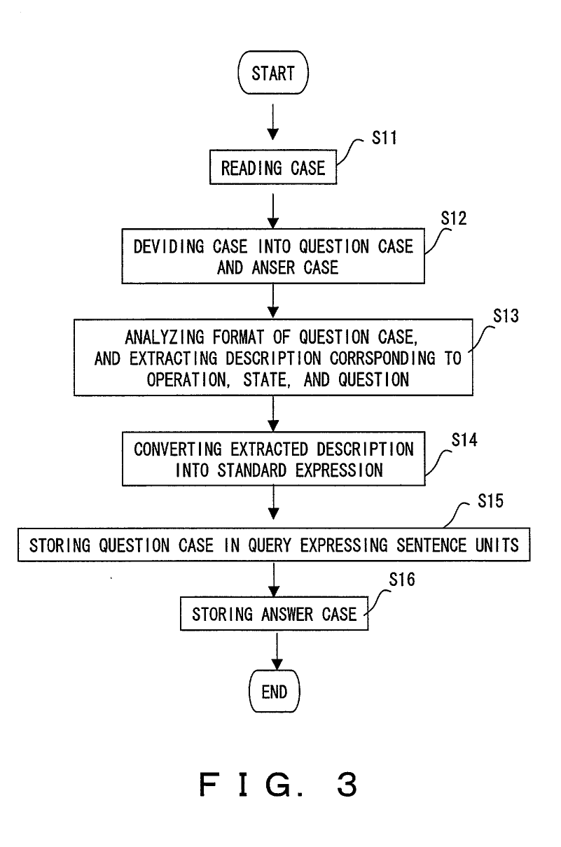

Described below is the process performed by the question and answering apparatus 11 with the above mentioned configuration. FIG. 3 is a flowchart of the process of storing a question case and an answer case by the question and answering case storage control unit 12.

The unit first reads a prepared case including a question case and an answer case (S11 in FIG. 3). Then, it divides the case into a question case and an answer case (S12), analyzes the format of the question case, and extracts the descriptions corresponding to ‘OPERATION’, ‘STATE’, and ‘QUESTION’ (S13).

An ‘OPERATION’ refers to the description corresponding to ‘what operation is requested’ or ‘what operation has been performed’. A ‘STATE’ refers to the description corresponding to, for example, ‘what trouble has occurred’, etc. A ‘QUESTION’ refers to the description corresponding to ‘what information is requested’, etc.

Next, the extracted query expressing sentence is converted into a standard expression according to a predetermined conversion rule (S14).

The description converted into a standard expression is divided into three query expressing sentences ‘OPERATION’, ‘STATE’, and ‘QUESTION’, and stored in the question and answering case accumulation unit 13 (S15). Finally, the answer case is associated with the query expressing sentences of the question case, and stored in the question and answering case accumulation unit 13 (S16).

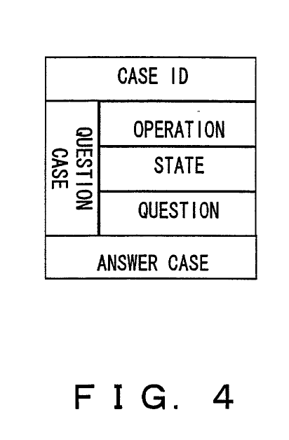

FIG. 4 shows the data structure of the question and answering case stored in the question and answering case accumulation unit 13.

As shown in FIG. 4, the question and answering case accumulation unit 13 stores each case in the format of a case ID, query expressing sentences (for example, an operation, a state, and a question) of a question case, and an answer case associated with one another.

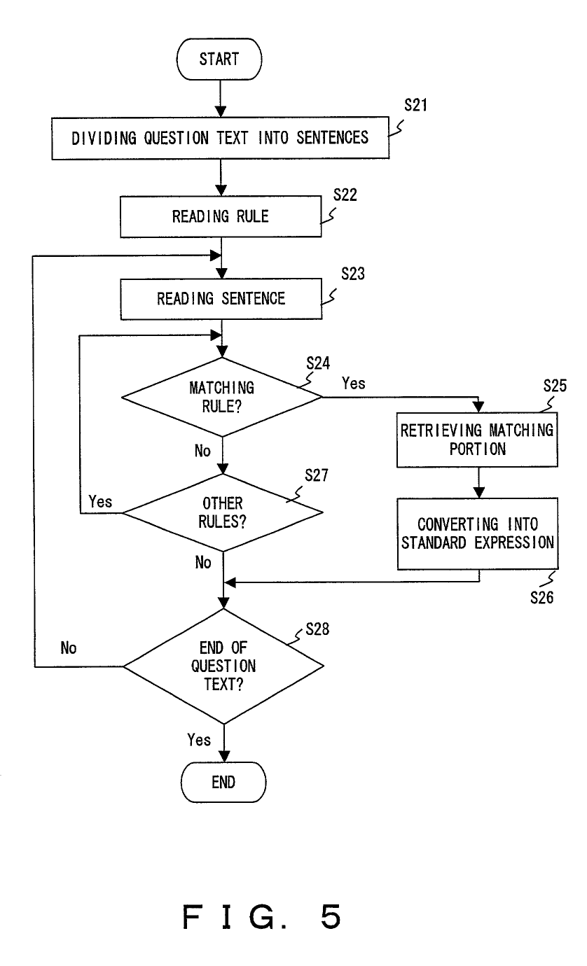

FIG. 5 is a flowchart of the process of extracting query expressing sentences in step S13 shown in FIG. 3.

First, a question case (question text) is divided sentence by sentence (S21 in FIG. 5). Then, the extraction rule is read to extract query expressing sentences (S22). One sentence divided from the question case is read (S23), and it is determined whether or not the sentence matches the extraction rule (S24).

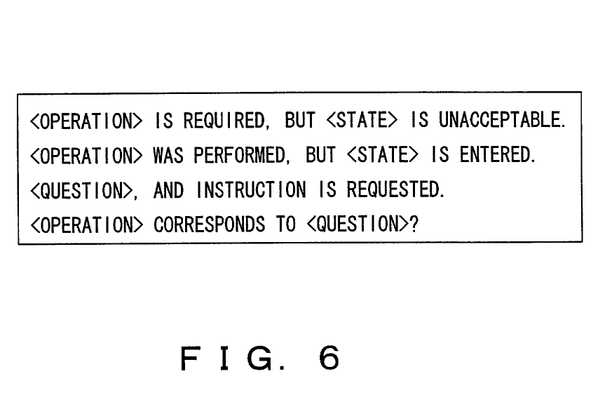

FIG. 6 shows an example of the extraction rule of query expressing sentences. In the rule, ‘ . . . IS REQUIRED’, and ‘ . . . WAS PERFORMED’ are extracted as related to ‘OPERATION’. ‘ . . . IS UNACCEPTABLE’ and ‘ . . . IS ENTERED’ are extracted as related to ‘STATE’. ‘ . . . , AND INSTRUCTION IS REQUESTED’ and ‘ . . . CORRESPONDS TO . . . ?’ are extracted as related to ‘QUESTION’. The extraction rule for query expressing sentences is also applied when query expressing sentences are extracted from question text.

Back in FIG. 5, when a read sentence matches the extraction rule (YES in S24), control is passed to step S25, and the portion matching the extraction rule is retrieved. Then, the process of converting the retrieved portion into a standard expression is performed (S26).

On the other hand, if the read sentence does not match the extraction rule (NO in S24), then control is passed to step S27, and it is determined whether or not another extraction rule exists. If yes (YES in S27), control is returned to step S24, and it is determined whether or not the read sentence matches the extraction rule.

If no other extraction rules exist (NO in S27), then control is passed to step S28, and it is determined whether or not the entire question text has been checked. If the check has been completed, the process terminates.

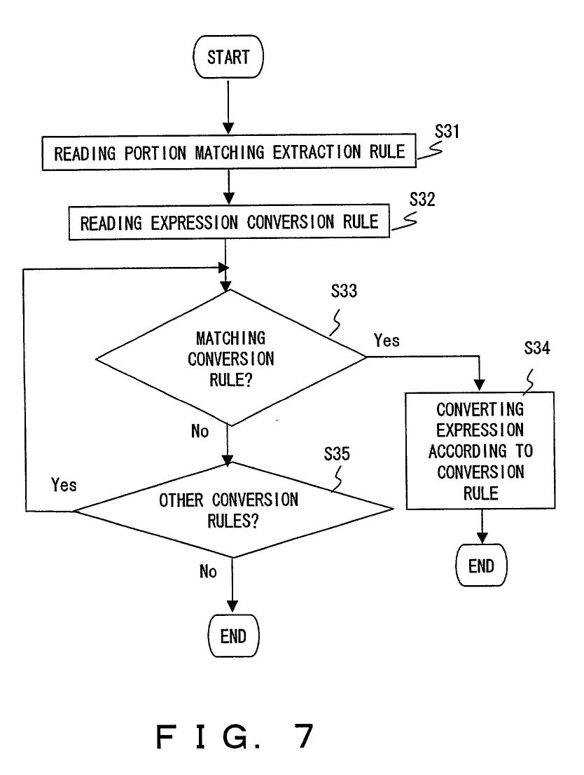

Then, the converting process into a standard expression in step S26 shown in FIG. 5 is described below by referring to the flowchart shown in FIG. 7.

First, the portion matching a query expressing sentence extraction rule is read (S31 in FIG. 7). Then, an expression conversion rule is read (S32). It is determined whether or not the description matching the query expressing sentence extraction rule also matches the expression conversion rule (S33). If it also matches the expression conversion rule (YES in S33), then control is passed to step S34, and the expression of sentences is converted according to the conversion rule.

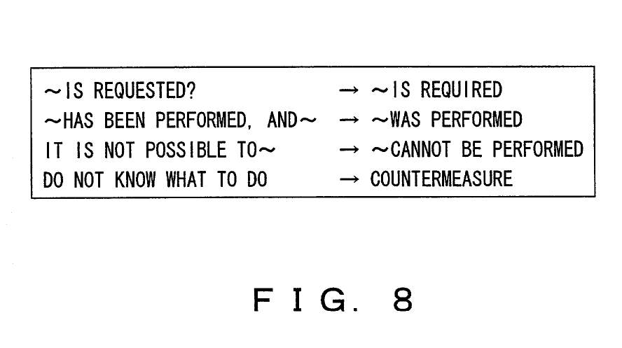

FIG. 8 shows an example of a conversion rule into a standard expression. For example, when the sentence ‘ . . . IS REQUESTED’ is extracted from a question case according to the query expressing sentence extraction rule, then the sentence is converted into ‘ . . . IS REQUIRED’. If the sentence ‘DO NOT KNOW WHAT TO DO’ is extracted from a question case, then the sentence is converted into ‘COUNTERMEASURE’.

Back in FIG. 7, when the sentence matching the query expressing sentence extraction rule does not match the expression conversion rule (NO in S33), it is determined whether or not another conversion rule exists (S35). If another conversion rule exists, then control is returned to step S33, and it is determined whether or not the sentence matches the conversion rule. If no other rules exist, then the process terminates.

As described above, if each of the query expressing sentences ‘OPERATION’, ‘STATE’, and ‘QUESTION’ is extracted, and the description of each query expressing sentence is converted into a standard expression, each element of the question case is stored in the question and answering case accumulation unit 13, and an answer case is associated with each query expressing sentence, and stored in the question and answering case accumulation unit 13.

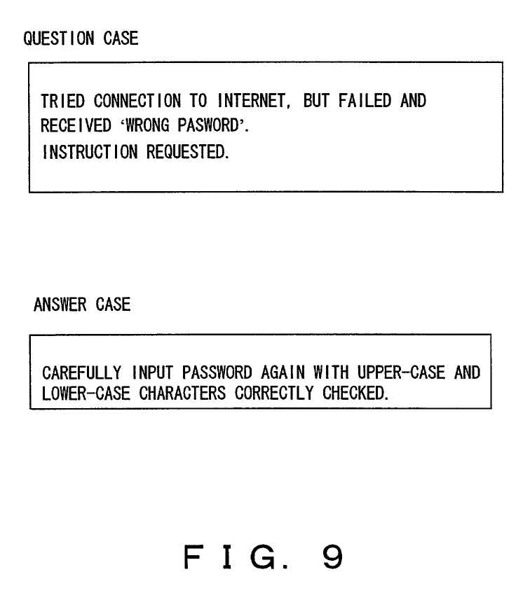

FIGS. 9 through 12 show examples of a question case and an answer case, and an example of data stored in the question and answering case accumulation unit 13.

FIG. 9 shows a question case of a connection to Internet, and an answer case of a suggestion that lower case and upper case characters have to be confirmed when entering a password.

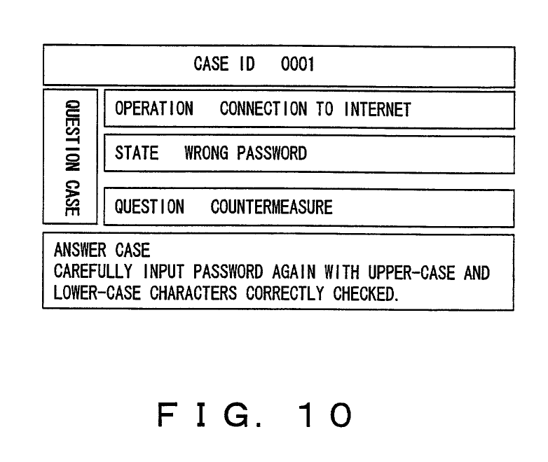

In this case, ‘CONNECTION TO INTERNET’ is extracted as a query expressing sentence of an ‘OPERATION’ and a ‘WRONG PASSWORD’ is extracted as a query expressing sentence of a ‘STATE’ by the question and answering case storage control unit 12. Then, as shown in FIG. 10, the case ID of 0001 is added to the query expressing sentences and an answer case, and they are stored in the question and answering case accumulation unit 13. Furthermore, the description ‘INSTRUCTION REQUIRED’ is extracted as a query expressing sentence of a ‘QUESTION’. This description is converted into a standard expression ‘COUNTERMEASURE’, and stored in the question and answering case accumulation unit 13.

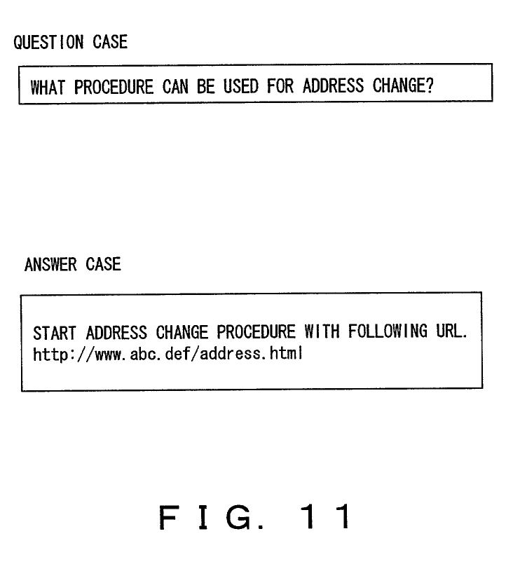

FIG. 11 shows a question case about the procedure of an address change and an answer case about the procedure of a change through Internet.

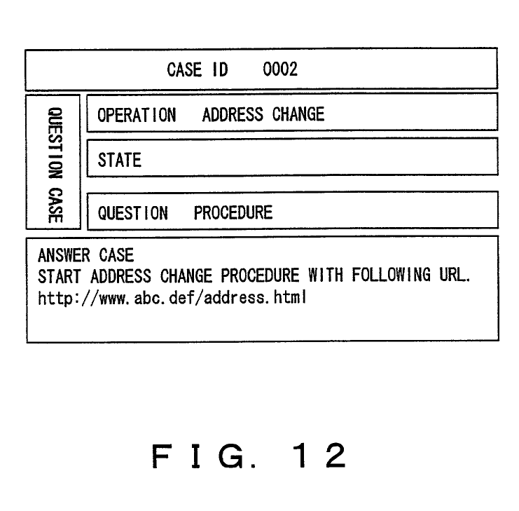

In this case, the ‘ADDRESS CHANGE’ is extracted as a query expressing sentence of an ‘OPERATION’ and a ‘PROCEDURE’ is extracted as a query expressing sentence of a ‘QUESTION’ by the question and answering case storage control unit 12. Then, as shown in FIG. 12, the case ID of 0002 is added to the query expressing sentences and an answer case, and they are stored in the question and answering case accumulation unit 13. Since the question case contains no description corresponding to a ‘STATE’, the query expressing sentence column is blank.

In the above mentioned process, the descriptions corresponding to the three query expressing sentences of ‘OPERATION’, ‘STATE’, and ‘QUESTION’ are extracted from a prepared question case, the extracted query expressing sentences, answer case, and case ID are grouped into a set of data, and the data is stored in the question and answering case accumulation unit 13.

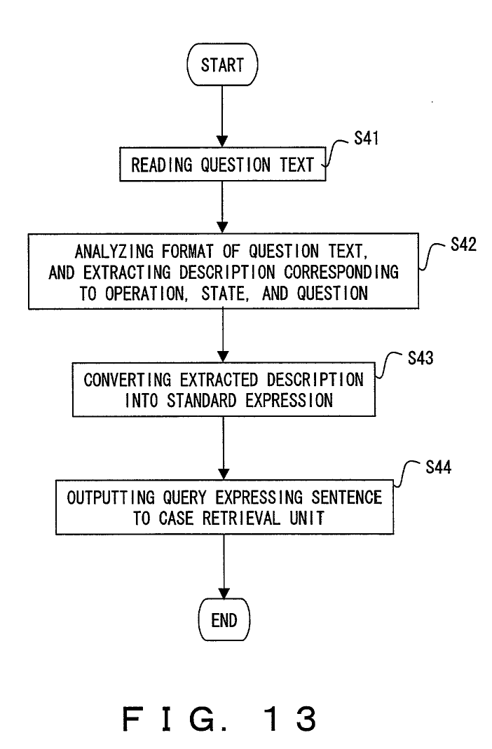

The process of the question extraction unit 14 extracting query expressing sentences from the question text transmitted from a questioner by electronic mail, etc. is described below by referring to the flowchart shown in FIG. 13.

The question extraction unit 14 reads question text transmitted from a questioner (S41 in FIG. 13). Then, it analyzes the format of the question text, and extracts the descriptions corresponding to the three query expressing sentences of ‘OPERATION’, ‘STATE’, and ‘QUESTION’ according to the above mentioned question and answering apparatus (S42). Then, according to the above mentioned conversion rule into a standard expression, the extracted description is converted into a standard expression (S43). These processes are the same as the processes of the question and answering case storage control unit 12 extracting a query expressing sentence from a question case and converting it into a standard expression.

Finally, the description converted into a standard expression is output as a query expressing sentence to the case retrieval unit 15 (S44).

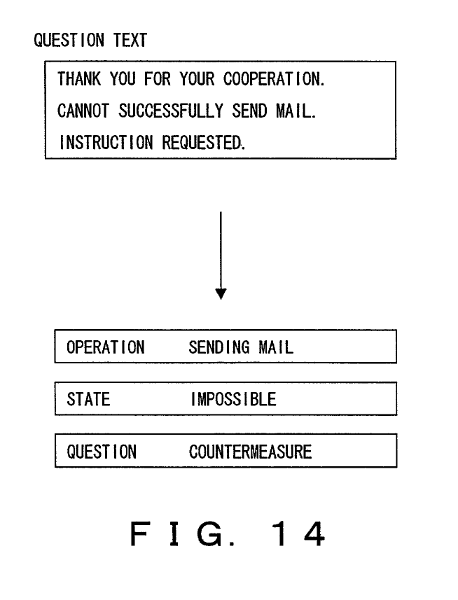

FIG. 14 shows an example of the question text transmitted by electronic mail and a query expressing sentence extracted from the question text.

Since the description ‘THANK YOU FOR YOUR COOPERATION’ in line 1 of the question text as shown in FIG. 14 is a salutation, it is removed by the format analysis. From and after line 2, ‘SEND MAIL’ is extracted as the description corresponding to the ‘OPERATION’. Although ‘CANNOT SUCCESSFULLY SEND’ is extracted as the description corresponding to the ‘STATE’, the description is converted into a standard expression ‘IMPOSSIBLE’. Furthermore, ‘INSTRUCTION REQUIRED’ is extracted, converted into a standard expression ‘COUNTERMEASURE’, and is output to the case retrieval unit 15.

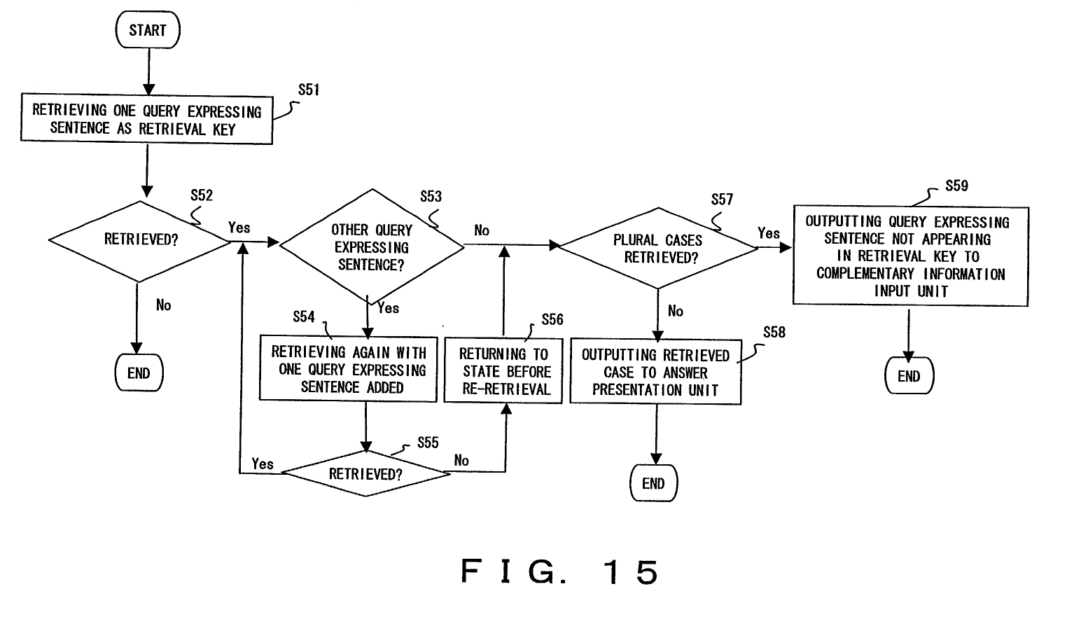

Then, the contents of the process performed by the case retrieval unit 15 is described below by referring to the flowchart shown in FIG. 15.

The case retrieval unit 15 retrieves the query expressing sentences of the question case stored in the question and answering case accumulation unit 13 using one of the query expressing sentences input from the question extraction unit 14 as a retrieval key (S51 in FIG. 15). Then, it is determines whether or not the question case including the query expressing sentence used as the retrieval key has been retrieved (S52). When the corresponding question case is retrieved (YES in S52), control is passed to step S53, and it is determined whether or not another query expressing sentence exists.

When other query expressing sentences exist, that is, when other query expressing sentences are input from the question extraction unit 14 (YES in S53), control is passed to step S54, and one of other query expressing sentences is added to the retrieval key, and the retrieving process is performed again.

Then, it is determined whether or not a question case has been retrieved by the re-retrieving process (S55). If a question case has been retrieved (YES in S55), then control is returned to step S53, and it is determined whether or not other query expressing sentences exist. If other query expressing sentences exist, then the re-retrieving process is performed by adding the query expressing sentences to the retrieval key.

If the re-retrieving process is perform after adding the query expressing sentences, and no question case has been retrieved (NO in S55), then control is passed to step S56, and the state before the re-retrieval, that is, the state in which a question case is retrieved before the re-retrieving process is performed by adding the retrieval key, is entered again, and control is passed to the subsequent step S57.

When it is determined in step S53 that no other query expressing sentences exist (NO in S53), control is passed to step S57.

In step S57, it is determined whether or not there are a plurality of cases retrieved. If only one question case and one answer case are retrieved (NO in S57), then control is passed to step S58, and the retrieved question case and answer case are output to the answer presentation unit 17.

On the other hand, if there are a plurality of retrieved question cases and answer cases (YES in S57), control is passed to step S59, and a query expressing sentence not used as a retrieval key in the query expressing sentences contained in the retrieved question cases is output to the complementary information input unit 16 as complementary information.

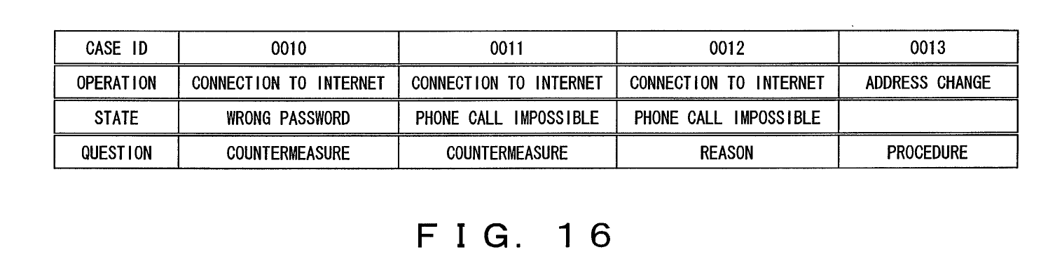

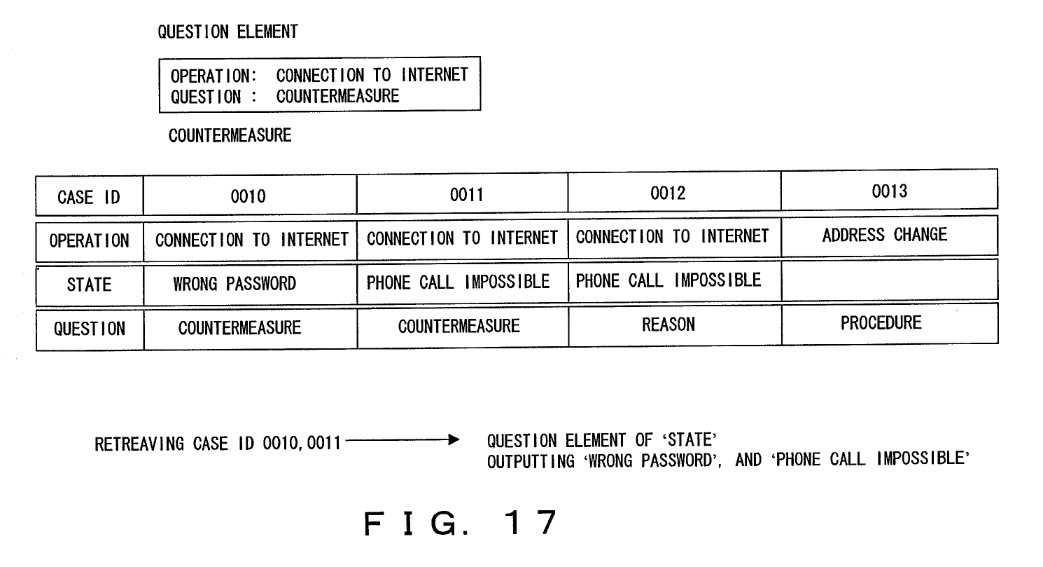

FIG. 16 shows a question case stored in the question and answering case accumulation unit 13. FIG. 17 shows the process of retrieving a case in response to the question case shown in FIG. 16. Described below are the process of extracting ‘CONNECTION TO INTERNET’ as an element of the ‘OPERATION’ from the question text from a questioner, and the process of extracting ‘COUNTERMEASURE’ as an element of the ‘QUESTION’ when the question and answering case accumulation unit 13 stores four cases having the case IDs 0010 through 0013 as shown in FIG. 16.

First, if the question case containing ‘CONNECTION TO INTERNET’ is retrieved as an element of the ‘OPERATION’, then the three cases having the case IDs 0010, 0011, and 0012 are retrieved. When the re-retrieving process is performed by adding ‘COUNTERMEASURE’ as an element of the ‘QUESTION’, two cases having the case IDs 0010 and 0011 containing ‘CONNECTION TO INTERNET’ as an element of the ‘OPERATION’, and containing the ‘COUNTERMEASURE’ as an element of the ‘QUESTION’ are retrieved.

In this case, since there are no other query expressing sentences extracted from the question text, the question case cannot be limited any more from the question text. Therefore, the query expressing sentences contained in the retrieved question case, but not contained in the question text, that is, ‘WRONG PASSWORD’ AND ‘PHONE CALL IMPOSSIBLE’, which are query expressing sentences of the ‘STATE’, are output as complementary information to the complementary information input unit 16.

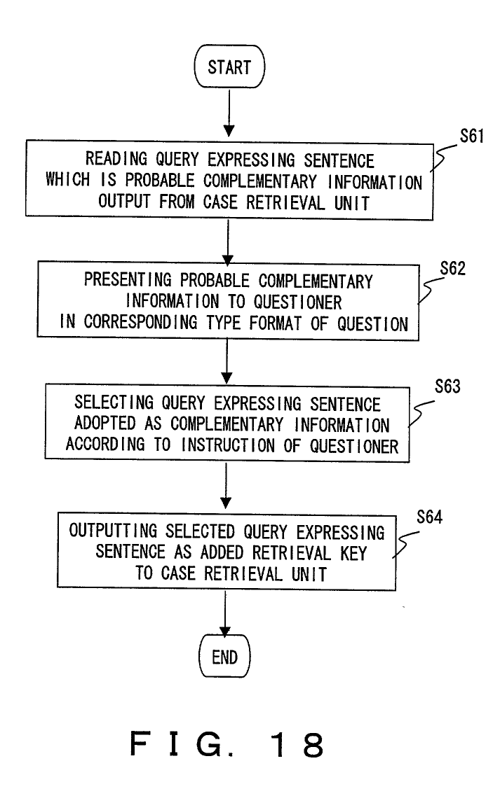

Next, the processes of the complementary information input unit 16 presenting and selecting complementary information according to the complementary information output from the case retrieval unit 15 are described below by referring to the flowchart shown in FIG. 18.

The complementary information input unit 16 reads the query expressing sentences which are probable complementary information output from the case retrieval unit 15 (S61 in FIG. 18), and presents probable complementary information in the format corresponding to the type of query expressing sentence to the questioner (S62).

If a specific query expressing sentence is selected by the questioner from the presented probable complementary information, then the complementary information input unit 16 adopts the query expressing sentence selected by the questioner as complementary information (S63), and outputs the query expressing sentence selected by the questioner as an additional retrieval key to the case retrieval unit 15 (S64).

When the complementary information input unit 16 inputs an additional query expressing sentence, the case retrieval unit 15 limits the question case by performing the re-retrieving process with the input query expressing sentence added to the retrieval key. If the number of remaining question cases is reduced to one, the question case is output to the answer presentation unit 17.

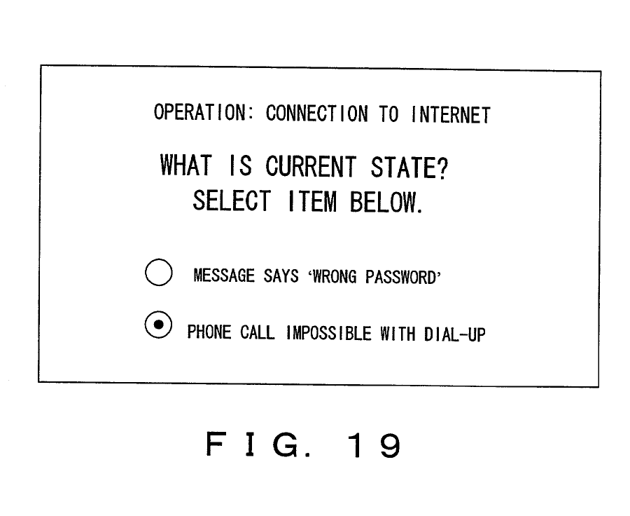

FIG. 19 shows an example of the complementary information input unit 16 presenting probable complementary information and the questioner selecting probable complementary information.

For example, since no query expressing sentence of the ‘STATE’ is contained in the question text in the example of retrieval shown in FIG. 17, and query expressing sentences of the ‘STATE’ are contained in the retrieved question cases, the query expressing sentences of the ‘STATE’ of the question cases are presented as probable complementary information. Therefore, as shown in FIG. 19, corresponding to the query expressing sentences of the ‘STATE’, the sentence ‘WHAT IS CURRENT STATE?’ and the complementary information for selection between the two query expressing sentences, that is, ‘WRONG PASSWORD’, and ‘PHONE CALL IMPOSSIBLE WITH DIAL-UP’, are presented to the questioner. In the example shown in FIG. 19, the questioner selects ‘PHONE CALL IMPOSSIBLE WITH DIAL-UP’ as complementary information in response to the presentation of the complementary information.

The complementary information selected by the questioner, that is, the query expressing sentences, are output from the complementary information input unit 16 to the case retrieval unit 15, and the case retrieval unit 15 adds the selected query expressing sentences (in this example, ‘PHONE CALL IMPOSSIBLE’) to the retrieval key, and performs the re-retrieving process. As a result, a question case containing three query expressing sentences of ‘CONNECTION TO INTERNET’ as an element of the ‘OPERATION’, and ‘COUNTERMEASURE’ as an element of the ‘QUESTION’, and ‘PHONE CALL IMPOSSIBLE’ as an element of the ‘STATE’ from the four question cases, for example, the case ID 0011 corresponding to the question case is output to the answer presentation unit 17.

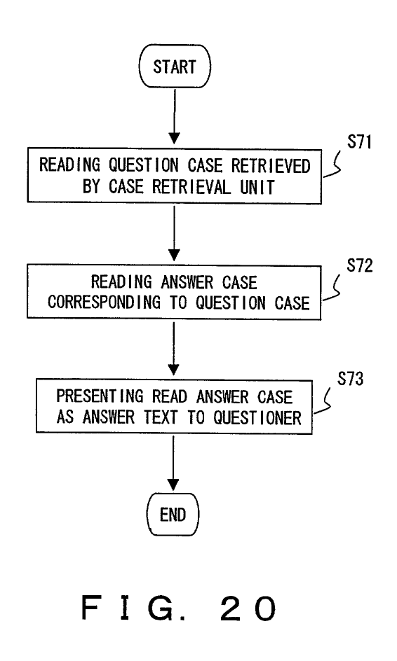

Next, the process performed by the answer presentation unit 17 when the question case is limited as described above is described below by referring to FIG. 20.

The answer presentation unit 17 reads the question case retrieved by the case retrieval unit 15 (S71 in FIG. 20). Then, it reads the answer case corresponding to the retrieved question case from the question and answering case accumulation unit 13 (S72). Reading the question case is performed by, for example, reading from the question and answering case accumulation unit 13 the answer case specified by the case ID output from the case retrieval unit 15. Then, the read answer case is presented to the questioner (S73).

In the above mentioned process, an answer case corresponding to the question case of the questioner can be retrieved from the question and answering case accumulation unit 13, and can be automatically presented to the questioner.

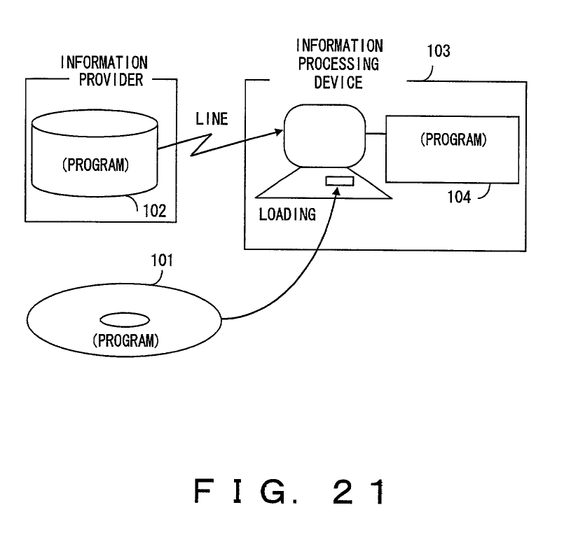

FIG. 21 shows the process of storing a program for realizing the function of the question and answering apparatus 11 in a portable storage medium 101 such as CD-ROM, a floppy disk, etc., or in a storage device 102 of a program provider, loading the program into an information processing device 103, and executing the program.

When the program is stored in the portable storage medium 101 such as CD-ROM, a floppy disk, etc., the program is read by inserting the portable storage medium 101 into the drive device of the information processing device 103, and the read program is stored in a storage device 104 such as RAM, a hard disk, etc., and is then executed. When the program is provided by a program provider through a communications line, the program stored in the storage device 102 of the program provider, memory, etc. is received by the information processing device 103 through the communications line, the received program is stored in the storage device 104 such as RAM, a hard disk, etc., and is then executed. The program stored in the portable storage medium 101 can have a part of the function of the program described above according to an embodiment of the present invention.

According to the above mentioned embodiments, a plurality of query expressing sentences are extracted from a question case, the query expressing sentences are associated with an answer case and stored in the question and answering case accumulation unit 13, query expressing sentences are extracted from the question text transmitted from a questioner by electronic mail, etc., a question case having matching query expressing sentences is retrieved, and an answer case corresponding to the question case is presented to the questioner. Therefore, the appropriate answer corresponding to the contents of the question can be retrieved and presented to the questioner.

Furthermore, when there are a plurality of answer cases retrieved from question text, the query expressing sentences contained in the retrieved question cases, but not contained in the question text, are presented to the questioner as probable complementary information for limiting the question case, and the questioner selects specific complementary information from the probable complementary information to perform a re-retrieving process so that the question case can be limited. As a result, an appropriate answer can be retrieved and presented to the questioner although there is insufficient information in the question text.

In addition, when query expressing sentences are extracted from a prepared question case and stored in the question and answering case accumulation unit 13, the descriptions extracted as the elements ‘OPERATION’, ‘STATE’, and ‘QUESTION’ are converted into standard expressions so that descriptions can be necessarily converted into standard expressions when query expressing sentences are extracted from question text, thereby successfully avoiding the problem that the expressions do not match each other between question text and a question case, and cannot be extracted in a retrieving process. Therefore, there is the strong possibility that a question case corresponding to the contents of the question can be successfully retrieved with high retrieval precision.

The above mentioned embodiments of the present invention is applied when question text is transmitted by electronic mail, but can also be applied to a question input in a method other than the electronic mail. For example, a question input by voice is recognized and converted into text, or query expressing sentences are extracted as voice data, and an answer case corresponding to the contents of the question can be retrieved using the extracted query expressing sentences as a retrieval key.

In this case, since it is not necessary for an operator to be present in the call center, etc., the labor for telephone operators, etc. can be reduced, and the costs of service staffs can be considerably reduced.

Furthermore, the query expressing sentences are not limited to the above mentioned ‘OPERATION’, ‘STATE’, and ‘QUESTION’, but can be increased and set depending on the target questioner and the contents of a question.

It is not necessary that the configuration of the question and answering apparatus 11 is the same as what is shown in FIG. 2. That is, a part of the function of the question and answering apparatus 11 can be omitted or shared. For example, When question and answering cases from which query expressing sentences are extracted are prepared in advance, the question and answering case storage control unit 12 can be omitted. The function of extracting query expressing sentences from a question case stored in the question and answering case storage control unit 12 and the function of extracting query expressing sentences from the question text of the question extraction unit 14 can be realized by one block.

According to the above mentioned embodiments, an appropriate answer corresponding to a question can be presented to a questioner by using the query expressing sentences extracted from the question of a questioner as a retrieval key, and retrieving query expressing sentences of a question case stored in advance. Furthermore, when there is no sufficient information for retrieval, the query expressing sentences of a question case obtained by a retrieving process can be presented as probable complementary information, and the questioner can select the complementary information, thereby limiting the question case and enhancing the retrieval precision.

What is claimed is:

1. A question and answering apparatus, comprising:
a question and answering case storage unit storing question elements of a plurality of question cases and answer cases;
a question extraction unit extracting a question element from a question received from a questioner;
a case retrieval unit retrieving the question element extracted by said question extraction unit from said question and answering case storage unit; and
an answer presentation unit presenting an answer case corresponding to a question case containing the question element retrieved by said case retrieval unit to the questioner.

2. The apparatus according to claim 1, further comprising
a complementary information presentation/selection unit presenting to the questioner, when there are a plurality of question cases retrieved by said case retrieval unit, a question element contained in the question elements of the retrieved question cases, but not contained in the question of the questioner as complementary information, and accepting complementary information selected by the questioner.

3. The apparatus according to claim 2, wherein
said case retrieval unit performs a re-retrieving process by adding a selected question element to a retrieval key when the questioner selects complementary information, and limits the question case.

4. The apparatus according to claim 1, further comprising
a question and answering case storage control unit extracting respective question elements from a plurality of question cases, and storing a plurality of question elements of each question case associated with an answer case in said question and answering case storage unit.

5. The apparatus according to claim 1, wherein
said question and answering case storage unit stores a question element converted into a standard expression according to a predetermined conversion rule;
said question extraction unit converts an extracted question element into a standard expression according to the predetermined conversion rule.

6. The apparatus according to claim 1, wherein
said question and answering case storage control unit converts a question element of an extracted question case into a standard expression according to a predetermined conversion rule, and stores a conversion result in said question and answering case storage unit.

7. The apparatus according to claim 1, wherein
said case retrieval unit retrieves a question element converted into a standard expression according to a predetermined conversion rule and stored in said question and answering case storage unit using as a retrieval key a question element of a question text converted into the standard expression according to the predetermined conversion rule, and retrieves a question case containing the retrieval key.

8. The apparatus according to claim 1, wherein
said question extraction unit extracts a question element by analyzing a format of a question text.

9. A question and answering method, comprising:
storing a question element extracted from a question case and an answer case;
extracting a question element from a question received from a questioner;
retrieving a question case containing extracted question element; and
presenting an answer case corresponding to the retrieved question case to the questioner.

10. The method according to claim 9, wherein
when there are a plurality of question cases retrieved by said case retrieval unit, a question element contained in the question elements of the retrieved question cases, but not contained in the question of the questioner is presented as complementary information to the questioner, and complementary information selected by the questioner is accepted.

11. The method according to claim 10, wherein
when the questioner selects complementary information, a re-retrieving process is performed by adding a selected question element to a retrieval key to limit the question case.

12. The method according to claim 9, wherein
respective question elements are extracted from a plurality of question cases, and a plurality of question elements of each question case are stored after being associated with the answer case.

13. A computer-executable program, realizing the functions of:
storing a question element extracted from a question case and an answer case;
extracting a question element from a question received from a questioner;
retrieving a question case containing extracted question element; and
presenting an answer case corresponding to the retrieved question case to the questioner.

14. The program according to claim 13, wherein
when there are a plurality of retrieved question cases, a question element contained in the question elements of the plurality of question cases, but not contained in the question of the questioner is presented as complementary information to the questioner, and complementary information selected by the questioner is accepted.

15. A computer-readable storage medium storing a program comprising the functions of:
storing a question element extracted from a question case and an answer case;
extracting a question element from a question received from a questioner;
retrieving a question case containing extracted question element; and
presenting an answer case corresponding to the retrieved question case to the questioner.
